(19) United States
(12) Patent Application Publication
(10) Pub. No.: US 2026/0146795 A1
(43) Pub. Date: May 28, 2026

(54) FURNACE VESSEL FOR ELECTRIC ARC, METALLURGICAL OR REFINING FURNACES AND SYSTEM THEREOF

(71) Applicant: Amerifab, Inc., Indianopolis, IN (US)

(72) Inventor: Richard J. Manasek, Carmel, IN (US)

(21) Appl. No.: 19/401,876

(22) Filed: Nov. 26, 2025

Related U.S. Application Data
(60) Provisional application No. 63/725,686, filed on Nov. 27, 2024.

(51) Int. Cl. F27B 3/24; F27D 9/00

(52) U.S. Cl. CPC F27B 3/24; F27D 9/00; F27D 2009/0013; F27D 2009/0021

(57) ABSTRACT

A metallurgical furnace vessel includes a hearth and a sidewall structure including a first sidewall portion extending from a first end to a second end at a first sidewall angle from a first axis. The sidewall structure is coupled to the hearth such that the first sidewall angle is within a range from a lower threshold of 0.1° to an upper threshold of 25°.

### RELATED APPLICATIONS

This application claims the benefit of U.S. Provisional Patent Application Ser. No. 63/725,686, filed November 27, 2024, the disclosure of which is incorporated by reference in its entirety.

### FIELD OF THE DISCLOSURE

The present disclosure relates generally to an apparatus for increasing the capacity of electric arc furnaces, metallurgical furnaces, including metal smelting and refining furnaces. In particular, the disclosure relates to the furnace vessel of those furnaces.

### BACKGROUND

Enlarging furnace vessels without a total tear out is difficult due to melt shop constraints. Additionally, revamping to increase heat capacity is difficult without modifying bases and foundations of which the furnace rest. Therefore, there is a need for a new furnace structure to increase scrap capacity to maximize charges for increased yields.

### SUMMARY

In one implementation of the present disclosure, a metallurgical furnace vessel includes a hearth and a sidewall structure having a first sidewall portion extending from a first end to a second end at a first sidewall angle from a first axis. The sidewall structure is coupled to the hearth, and the first sidewall angle is within a range from a lower threshold of 0.1° to an upper threshold of 25°.

In one example of this implementation, the first sidewall angle is greater than an intermediate lower threshold of 5°. In a second example, the first sidewall angle is less than an intermediate upper threshold of 15°. In a third example, a heat exchanger system is coupled to sidewall structure. In a fourth example, the heat exchanger system comprises a panel of sinuously winding piping.

In a fifth example, the sinuously winding piping may be formed from one or more half pipes, half pipe returns, and half pipe elbows. In a sixth example, the heat exchanger system is disposed within a cavity at least partially defined by the first sidewall portion. In a seventh example, the first sidewall portion is conically shaped about the first axis. In an eighth example, the metallurgical furnace vessel includes a second sidewall portion coupled to the first sidewall portion, the second sidewall portion parallel to the first axis. In a ninth example, the first end has a first diameter and the second end has a second diameter, the first diameter less than the second diameter. In a tenth example, the vessel is asymmetrical.

In another implementation of the present disclosure, a metallurgical furnace shell includes a conical sidewall portion extending from a first end to a second end at least partially surrounding a first axis; wherein the first end of the conical sidewall portion has a first diameter; wherein the second end of the conical sidewall portion has a second diameter, the first diameter less than the second diameter.

In one example of this implementation, the furnace includes a flat sidewall portion coupled to the conical sidewall portion. In another example, the flat sidewall portion is coupled to the coupled a first edge and a second edge of the conical sidewall portion.

In a further implementation of the present disclosure, a metallurgical furnace sidewall includes a first sidewall portion extending from a first end to a second end and at least partially defining a cavity; wherein the first sidewall portion has a first sidewall angle relative to a first axis within a range from a lower threshold of 0.1° to an upper threshold of 25°.

In one example of this implementation, the furnace includes a second sidewall portion coupled to a first edge and a second edge of the first sidewall portion. In another example, the second sidewall portion is flat. In yet another example, the second sidewall portion at least partially defines the cavity.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 illustrates a cross-sectional schematic of a steel-making furnace;

FIG. 2 illustrates a side view of a furnace vessel;

FIG. 3 illustrates a top view of the furnace vessel of FIG. 2;

FIG. 4 illustrates a top view of a furnace sidewall structure;

FIG. 5 illustrates a side view of the furnace sidewall structure of FIG. 4; and

FIG. 6 illustrates a front view the furnace sidewall structure of FIG. 4.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

In an electric arc furnace (EAF), scrap is added to vessel to melt and produce liquid steel. Different sized vessels may be used but are limited due to melt shop constraints. Increasing the furnace volume allows for the capacity to produce more liquid steel per heat. Usually, increasing the lower diameter of the furnace requires the tilt platform to undergo expensive modifications or even be replaced. Enlarging furnace vessels without tearing out the entire furnace is often difficult due to melt shop space constraints. Additionally, revamping to increase heat capacity is difficult without modifying bases and foundations of which the furnace rests.

The following disclosure addresses a way to increase scrap capacity to produce more steel per heat. Additionally, this disclosure allows operators to maximize their charges for increased yields without overcharging. These advantages can all be accomplished without a total revamp of the furnace.

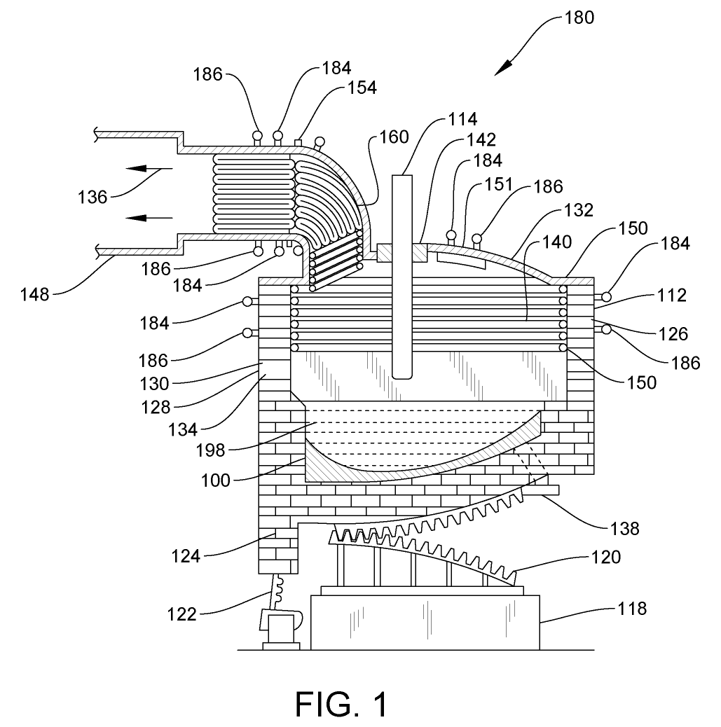

Referring to FIG. 1, one implementation of a furnace is illustrated as an EAF type furnace 180. While the EAF is disclosed as one example, it is understood the principles and teachings of the present disclosure may be readily applied in a basic oxygen furnace (BOF) and the like. In FIG. 1, an EAF 180 may include a furnace shell 112, a plurality of electrodes 114, an exhaust system, a working platform 118, a rocker tilting mechanism 120, a tilt cylinder 122, and an off gas chamber. The furnace shell 112 may be movably disposed upon the rocker tilt 120 or other tilting mechanism. Further, the rocker tilt 120 may be powered by the tilt cylinder 122. The rocker tilt 120 may also be further secured upon the working platform 118.

The furnace shell 112 may include a hearth 124, a sidewall structure 126, a spout 128, a spout door 130, and a roof 132. The spout 128 and spout door 130 are located on one side of the sidewall structure 126. In the open position, the spout 128 may allow intruding air 134 to enter the hearth 124 and partially burn gasses 136 produced from smelting. The hearth 124 is formed of a suitable refractory material. At one end of the hearth 124 is a pouring box having a tap means 138 at its lower end. During a melting operation, the tap means 138 is closed by a refractory plug, or a slidable gate. Thereafter, the furnace shell 112 is tilted, the tap means 138 is unplugged, or open and molten metal is poured into a teeming ladle, tundish, or other device, as desired.

The inside of sidewall structure 126 of the furnace shell 112 may be fitted with water cooled panels 140 of sinuously winding piping 150. The panels, in effect serve as an interior wall in the furnace 180. The manifolds, which supply cool water and a return, are in fluid communication with the panels 140. Typically, the manifolds are positioned peripherally in a fashion similar to the illustrated exhaust ducts.

The heat exchanger system produces a more efficient operation and prolongs the operation life of the EAF furnace 180. In one illustrative implementation, the panels 140 may be assembled such that the sinuously winding piping has a generally horizontal orientation. The panels 140 may also be assembled in any other orientation, for example a generally vertical orientation. The piping 150 can be linked with a linkage or have a base that is mounted to the wall. Alternatively, the panels 140 can be mounted such that the sinuously winding piping 150 has a generally vertical orientation. The upper ends of the panels 140 may define a circular rim at the upper margin of the sidewall structure 126 portion of the furnace 180.

The heat exchanger system can be fitted to the roof 132 of the furnace 180, wherein the water cooled panels 140 have a curvature that substantially follows the domed contour of the roof 132. The heat exchanger system may be deployed on the inside of sidewall structure 126 of the furnace 180, the roof 132 and the entrance of the exhaust system, as well as throughout the exhaust system. As such, the heat exchanger system can protect the furnace and cools the hot waste gasses 136 as they are ducted to a bag house or other filtering and air treatment facilities, where dust is collected and the gasses are vented to the atmosphere.

In operation, hot waste gasses 136, dust and fumes are removed from the hearth 124 through a vent in the furnace shell 112. The vent may be in communication with an exhaust system.

The panel 140 can have a plurality of axially arranged pipes 150. U-shaped returns or elbows can connect adjacent sectional lengths of piping or pipes 150 together to form a continuous piping system. Linkages and the like that additionally serve as spacers may be between adjacent pipes 150, and they provide structural integrity of the panel 140 and are determinative of curvature to the panel 140.

The heat exchanger system may include at least one panel of the sinuously winding piping 150 having an inlet (not shown) and an outlet (not shown), an input manifold in fluid communication with the inlet of the at least one panel, an-output manifold in fluid communication with the outlet of the at least one panel, and a cooling fluid flowing through the piping 150. The heat exchanger system cools hot fume gasses 136 and dust that is being evacuated from the metallurgical furnace 180 and its supporting components. The piping is an assemblage of sectional lengths of connected tubes mounted side-by-side, wherein the connected tubes are secured to each other with the linkage, therein forming the at least one panel 140.

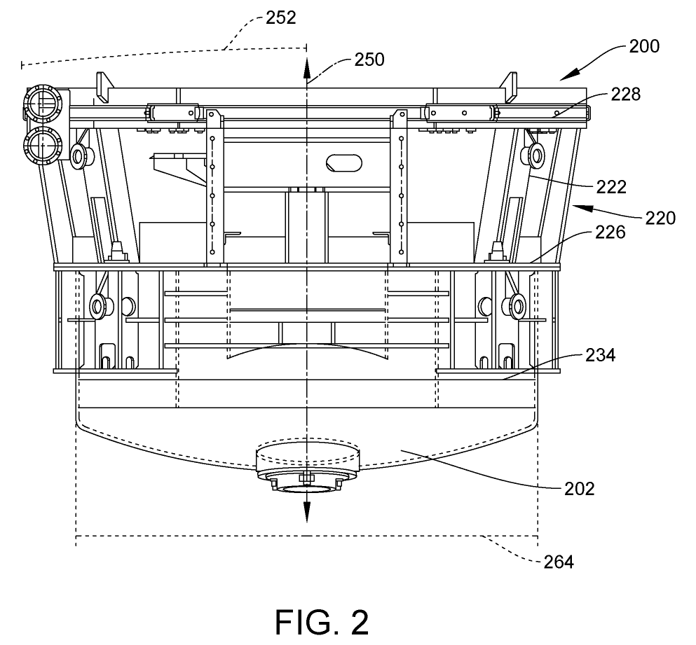

Referring to FIG. 2, a furnace vessel or furnace shell 200 is illustrated. The furnace vessel 200 may include a sidewall structure 220. The furnace vessel may also include a hearth 202. The sidewall structure 220 may be coupled to the hearth 202. The sidewall structure 220 may include a first sidewall portion 222 extending from a first end 226 to a second end 228. The first end 226 may have a first diameter and the second end 228 may have a second diameter. In some implementations, the first diameter is less than the second diameter.

In some implementations, the furnace vessel 200 may be asymmetrical. An advantage of the furnace vessel 200 being asymmetrical allows the furnace vessel 200 to accommodate peripheral interference surrounding the furnace vessel 200. In other implementations, the furnace vessel 200 may be symmetrical.

The first sidewall portion 222 may at least partially surround a first axis 250. In certain forms, the first axis 250 may be a central axis. In certain implementations, the first sidewall portion 222 may be conical in shape about a first axis 250. In other words, the first sidewall portion 222 may extend radially outward from the first end 226 to the second end 228 at a first sidewall angle 252 that is greater than 0° relative to the first axis 250. Having the first sidewall angle 252 greater than 0° allows for increased scrap capacity to produce more steel per heat and allows operators to maximize their charges without overcharging.

The first sidewall angle 252 may be within a range from a lower threshold to an upper threshold. The lower threshold may be defined as 0.1° relative to the first axis 250. The upper threshold may be defined as 25° relative to the first axis 250. In certain implementations, the first sidewall angle 252 may be greater than an intermediate lower threshold of 5° relative to the first axis 250. In certain implementations, the first sidewall angle 252 may be less than an intermediate upper threshold of 15° relative to the first axis 250. For example, the first sidewall angel 252 may be 10°.

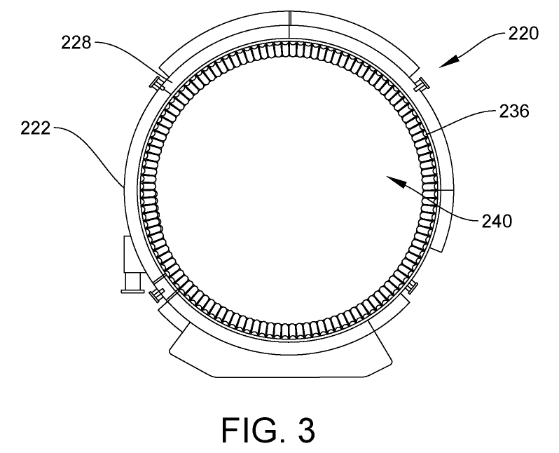

As illustrated in FIG. 2 and FIG. 3, the first end 226 of the first sidewall portion 222 may have a generally circular shape. The first end 226 may completely surround the first axis 250. Additionally, the second end 228 of the first wall portion 222 may completely surround the first axis 250.

The sidewall structure 220 may further include a lower sidewall portion 234. The lower sidewall portion 234 may be coupled to the first sidewall portion 222. As illustrated in FIG. 2, the lower sidewall portion 234 is positioned between the hearth 202 and the first sidewall portion 222. In some implementations, the lower sidewall portion 234 is generally cylindrical in shape.

The sidewall structure 220 may at least partially define a cavity 240. The first sidewall portion 222 may at least partially define the cavity 240. Additionally, the lower sidewall portion 234 may at least partially define the cavity 240.

The lower sidewall 234 may have a lower sidewall diameter 264. In some implementations, the lower sidewall diameter 264 may be the same as the first diameter of the first sidewall portion 222. Having the lower sidewall diameter 264 being the same as the first diameter allows the first end 226 of the first sidewall portion 222 to be aligned and positioned on the lower sidewall 234.

Referring to FIG. 3, a heat exchanger system 236 may be positioned at least partially inside the cavity 240. The heat exchanger system 236 may include a panel of sinuously winding piping. In some implementations, the sinuously winding piping may be formed from half pipes, half pipe returns, and half pipe elbows. Additionally or alternatively, the sinuously winding piping may be formed from full cylindrical pipes, returns, and elbows.

The heat exchanger system 236 may at least be coupled to the sidewall structure 220 on an inner surface 242 of the first sidewall portion 222. In some implementations, the heat exchanger system 236 may generally take the same shape as the sidewall structure 220. The piping may be curved or bent to match the curvature of the first sidewall portion 222 and/or second sidewall portion 224 to which it is being attached. In some implementations, the individual sections of piping are secured to each other with an angled linkage such that the resulting panel has a curvature that is comparable to the curvature of the sidewall structure 220.

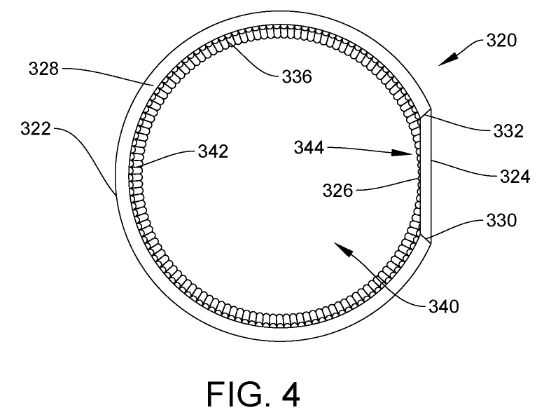

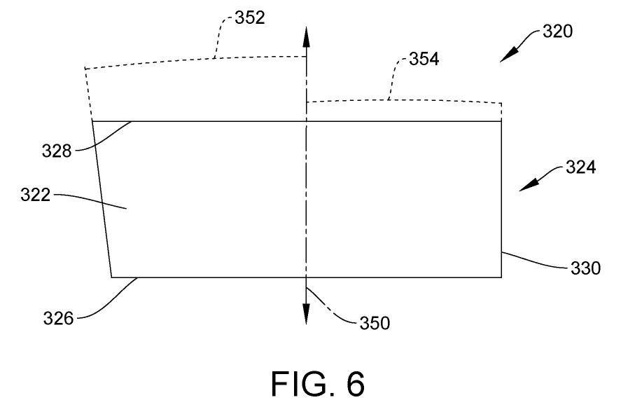

Referring now to FIGS. 4-6, a furnace vessel or furnace shell 300 is illustrated. The furnace vessel 300 comprises a sidewall structure 320. The furnace vessel may include a hearth 202. The sidewall structure 320 may be coupled to the hearth 202. The sidewall structure 320 may include a first sidewall portion 322 extending from a first end 326 to a second end 328. The first end 326 may have a first diameter 360 and the second end 328 may have a second diameter 362. In some implementations, the first diameter 360 is less than the second diameter 362. The sidewall structure 320 may further comprise a second sidewall portion 324. The second sidewall portion 324 may be coupled to the first sidewall portion 322. The second sidewall portion 324 may connect a first edge 330 of the first sidewall portion 322 and a second edge 332 of the first sidewall portion 322.

In some implementations, the furnace vessel 300 may be asymmetrical. An advantage of the furnace vessel 300 being asymmetrical allows the furnace vessel 300 to accommodate peripheral interference surrounding the furnace vessel 300. In other implementations, the furnace vessel 300 may be symmetrical.

The first sidewall portion 322 may at least partially surround a first axis 350. In certain forms, the first axis 350 may be a central axis. In certain implementations, the first sidewall portion 322 may be conical in shape about a first axis 350. In other words, the first sidewall portion 322 may extend radially outward from the first end 326 to the second end 328 at a first sidewall angle 352 that is greater than 0° relative to the first axis 350. Having the first sidewall angle 352 greater than 0° allows for increased scrap capacity to produce more steel per heat and allows operators to maximize their charges without overcharging.

The first sidewall angle 352 may be within a range from a lower threshold to an upper threshold. The lower threshold may be defined as 0.1° relative to the first axis 350. The upper threshold may be defined as 25° relative to the first axis 350. In certain implementations, the first sidewall angle 352 may be greater than an intermediate lower threshold of 5° relative to the first axis 350. In certain implementations, the first sidewall angle 352 may be less than an intermediate upper threshold of 15° relative to the first axis 350. For example, the first sidewall angel 352 may be 10°.

In some implementations, the second sidewall portion 324 may extend parallel to the first axis 350. In other words, in some implementations, the second sidewall portion 324 may extend at a second sidewall angle 354 of 0° relative to the first axis 350. For example, the second sidewall portion 324 may be flat and connect the first edge 330 of the first sidewall portion 322 to the second edge 332 of the first sidewall portion 322. Having the second sidewall portion 324 that is flat allows for equipment to be placed next to the furnace vessel 300. For example, a flat sidewall portion 324 allows for a gantry to be positioned next to the furnace vessel 300 to lift and remove the furnace roof.

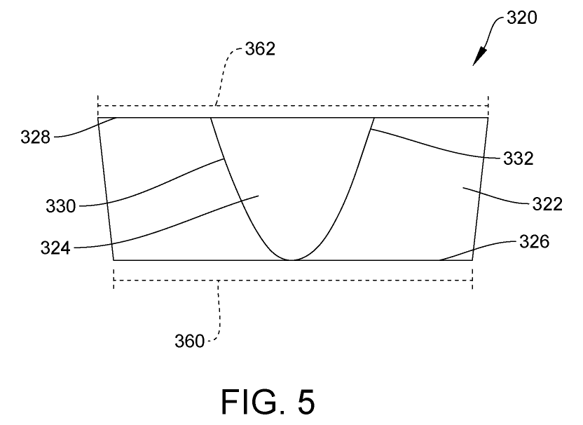

As illustrated in FIGS. 4-5, the first end 326 of the first sidewall portion 322 may have a generally circular shape. In certain forms, the first end 326 may completely surround the first axis 350. Alternatively, the first end 326 may not completely surround the first axis 350. In certain forms the second end 328 of the first wall portion 322 may at least be partially defined from the first edge 330 to the second edge 332 and may not completely surround the first axis 350.

In some other implementations, the second sidewall portion 324 may not extend parallel to the first axis 350. In other words, the second sidewall angle 354 may be greater than 0° relative the first axis 350. Additionally or alternatively, the second sidewall angle 354 may be less than the first sidewall angle 352.

The sidewall structure 320 may further include a lower sidewall portion. The lower sidewall portion 334 may be coupled to the first sidewall portion 322, the second sidewall portion 324, or both the first sidewall portion 322 and the second sidewall portion 324. In some implementations, the lower sidewall portion is generally cylindrical in shape.

The sidewall structure 320 may at least partially define a cavity 340. The first sidewall portion 322 may at least partially define the cavity 340. In certain implementations, the first sidewall portion 322 and the second sidewall portion 324 may at least partially define the cavity 340. Additionally, the lower sidewall portion may at least partially define the cavity 340.

The lower sidewall may have a lower sidewall diameter. In some implementations, the lower sidewall diameter may be the same as the first diameter 360 of the first sidewall portion 322. Having the lower sidewall diameter being the same as the first diameter 360 allows the first end 326 of the first sidewall portion 322 to be aligned and positioned on the lower sidewall.

The first sidewall portion 322 may be configured to be coupled to a pre-existing lower sidewall therefore eliminating the need to modify the base or foundation of which the furnace rest.

Referring to FIG. 4, a heat exchanger system 336 may be positioned at least partially inside the cavity 340. The heat exchanger system 336 may include a panel of sinuously winding piping. In some implementations, the sinuously winding piping may be formed from half pipes, half pipe returns, and half pipe elbows. Additionally or alternatively, the sinuously winding piping may be formed from full cylindrical pipes, returns, and elbows.

The heat exchanger system 336 may at least be coupled to the sidewall structure 320 on an inner surface 342 of the first sidewall portion 322. The heat exchanger system 336 may at least be coupled to the sidewall structure 320 on an inner surface 344 of the second sidewall portion 324. In some implementations, the heat exchanger system 336 may generally take the same shape as the sidewall structure 320. The piping may be curved or bent to match the curvature of the first sidewall portion 322 and/or second sidewall portion 324 to which it is being attached. More typically, the individual sections of piping are secured to each other with an angled linkage such that the resulting panel has a curvature that is comparable to the curvature of the sidewall structure 320.

While the disclosure has been illustrated and described in detail in the foregoing drawings and description, the same is to be considered as illustrative and not restrictive in character, it being understood that only illustrative implementations thereof have been shown and described and that all changes and modifications that come within the spirit of the disclosure are desired to be protected.

1. A metallurgical furnace vessel comprising:
a hearth; and
a sidewall structure including a first sidewall portion extending from a first end to a second end at a first sidewall angle from a first axis;
wherein the sidewall structure is coupled to the hearth;
wherein the first sidewall angle is within a range from a lower threshold of 0.1° to an upper threshold of 25°.

2. The metallurgical furnace vessel of claim 1, wherein the first sidewall angle is greater than an intermediate lower threshold of 5°.

3. The metallurgical furnace vessel of claim 1, wherein the first sidewall angle is less than an intermediate upper threshold of 15°.

4. The metallurgical furnace vessel of claim 1, further comprising a heat exchanger system coupled to sidewall structure.

5. The metallurgical furnace vessel of claim 4, wherein the heat exchanger system comprises a panel of sinuously winding piping.

6. The metallurgical furnace vessel of claim 5, wherein the sinuously winding piping may be formed from one or more half pipes, half pipe returns, and half pipe elbows.

7. The metallurgical furnace vessel of claim 5, wherein the heat exchanger system is disposed within a cavity at least partially defined by the first sidewall portion.

8. The metallurgical furnace vessel of claim 1, wherein the first sidewall portion is conically shaped about the first axis.

9. The metallurgical furnace vessel of claim 1, further comprising a second sidewall portion coupled to the first sidewall portion, the second sidewall portion parallel to the first axis.

10. The metallurgical furnace vessel of claim 1, wherein the first end has a first diameter and the second end has a second diameter, the first diameter less than the second diameter.

11. The metallurgical furnace vessel of claim 1, wherein the vessel is asymmetrical.

12. A metallurgical furnace shell comprising:
a conical sidewall portion extending from a first end to a second end at least partially surrounding a first axis;
wherein the first end of the conical sidewall portion has a first diameter;
wherein the second end of the conical sidewall portion has a second diameter, the first diameter less than the second diameter.

13. The metallurgical furnace shell of claim 12 further comprising a flat sidewall portion coupled to the conical sidewall portion.

14. The metallurgical furnace shell of claim 13, wherein the flat sidewall portion is coupled to the coupled a first edge and a second edge of the conical sidewall portion.

15. A metallurgical furnace sidewall comprising:
a first sidewall portion extending from a first end to a second end and at least partially defining a cavity;
wherein the first sidewall portion has a first sidewall angle relative to a first axis within a range from a lower threshold of 0.1° to an upper threshold of 25°.

16. The metallurgical furnace sidewall of claim 15 further comprising a second sidewall portion coupled to a first edge and a second edge of the first sidewall portion.

17. The metallurgical furnace sidewall of claim 16, wherein the second sidewall portion is flat.

18. The metallurgical furnace sidewall of claim 17, wherein the second sidewall portion at least partially defines the cavity.
